(19) United States
(12) Patent Application Publication
(10) Pub. No.: US 2005/0126410 A1
(43) Pub. Date: Jun. 16, 2005

(54) System and method for printing an alignment film

(75) Inventors: Min-Young Won, Yongin-si (KR); Jong-Won Kim, Cheonan-si (KR); Jung-Ho Kang, Cheonan-si (KR); Hyeong-Ryeol Baek, Asan-si (KR)

Correspondence Address: MacPherson Kwok Chen & Heid LLP;Suite 226, 1762 Technology Drive, San Jose, CA, 95110, US

(73) Assignee: SAMSUNG ELECTRONICS CO., LTD., Suwon-si (KR)

(21) Appl. No.: 10/981,859

(22) Filed: Nov. 5, 2004

(30) Foreign Application Priority Data
Nov. 7, 2003 (KR) 2003-0078599
Nov. 7, 2003 (KR) 2003-0078600
Aug. 4, 2004 (KR) 2003-0061402

(51) Int. Cl. B41F 31/02

(52) U.S. Cl. 101/359

(57) ABSTRACT

A system and method for advantageously forming an alignment film are provided. An anilox roll is operably engaged with a printing roll to print an alignment film onto a substrate, in one example including a liquid crystal display panel. Multiple rotations of the printing roll are used to provide efficiency and flexibility in printing a variety of alignment film patterns onto a variety of substrates.

### BACKGROUND

(a) Field of the Invention

The present invention relates to liquid crystal displays, and more particularly to a system and method for providing an alignment film.

(b) Description of Related Art

A liquid crystal display (LCD) is one of the most widely used flat panel displays. An LCD includes two panels having field generating electrodes and alignment films thereon. A liquid crystal layer is interposed between the panels. The alignment film determines initial orientations of the liquid crystal molecules, and the field generating electrodes generate an electric field to change the orientations of the liquid crystal molecules. An incident light passing through the liquid crystal layer experiences electromagnetic force depending on the orientations of the liquid crystal molecules to thereby change the polarization of the light due to the dielectric anisotropy of the liquid crystal. Appropriately arranged polarizers can then change the transmittance of the incident light depending on the polarization of the light, thereby displaying desired images.

An active matrix LCD includes a plurality of pixel electrodes and a common electrode for generating electric fields, a plurality of switching elements such as thin film transistors (TFTs) for controlling data voltages applied to the pixel electrodes, a plurality of signal lines for transmitting data voltages and control signals for controlling the TFTs, a plurality of color filters for color display, and a seal for adhering the two panels and confining the liquid crystal. The above-described elements of an LCD are formed by several steps of deposition, photolithography, and etching, and the elements of each panel are then covered with an alignment film.

Typically, the alignment film is formed by spin coating or printing. A printing device for the alignment film generally includes several metal rollers and a rubber plate, such as an anilox roll and a printing roll engaged with each other and the rubber plates attached on the printing roll. The size of the rolls and the rubber plates are established such that the alignment film is coated on the entire mother glass substrate by a single rotation of the printing roll.

Disadvantageously, the size and the weight of the rolls and the rubber plates are required to be increased as the size of a mother glass substrate increases. Thus, it becomes difficult and costly to manufacture and/or modify the printing device. Accordingly, an efficient and easily modifiable system and method for providing an alignment film are desirable.

### SUMMARY

A system and method for advantageously forming an alignment film are provided. Multiple rotations of a printing roll are used to provide an alignment film on a substrate, allowing for efficiency and flexibility in providing a variety of alignment patterns onto a variety of substrates.

In accordance with an embodiment of the present invention, a system for printing an alignment film is provided, comprising an anilox roll operably engaged with a dispenser for providing an alignment material on the anilox roll, and a printing roll operably engaged with the anilox roll to receive alignment material. The system further includes a table operably engaged with the printing roll, the table mounting a substrate onto which is transferred alignment material from the printing roll.

In accordance with another embodiment of the present invention, another system for printing an alignment film is provided. An anilox roll and a printing roll are again included, and a table is operably engaged with the printing roll, the table mounting a substrate onto which is transferred alignment material from the printing roll via multiple rotations of the printing roll.

In accordance with yet another embodiment of the present invention, a method of printing an alignment film is provided, comprising transferring alignment material from a dispenser to an anilox roll, transferring alignment material from the anilox roll to a printing roll including a printing pattern, and transferring alignment material from the printing roll to a substrate mounted on a table via multiple rotations of the printing roll.

In accordance with yet another embodiment of the present invention, a method of printing an alignment film includes transferring alignment material from the printing roll to a substrate mounted on a table via multiple rotations of the printing roll to form an alignment film, and then patterning the alignment film.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

The present invention will become more apparent by describing embodiments thereof in detail with reference to the accompanying drawings in which:

FIGS. 1 and 2 are lateral sectional views of apparatuses for forming an alignment film according to embodiments of the present invention;

FIG. 3 schematically illustrates the printing of an alignment film by a printing roll of the apparatuses shown in FIGS. 1 and 2;

FIGS. 4 and 5 are expanded sectional views of the printing roll of the apparatuses shown in FIGS. 1 and 2, respectively;

FIG. 6 is a sectional view of a rubber plate for a printing roll according to an embodiment of the present invention;

FIG. 7 illustrates the formation of a printing pattern on the rubber plate shown in FIG. 6 using a laser beam process in accordance with an embodiment of the present invention;

FIG. 8 illustrates the formation of a printing pattern on the rubber plate shown in FIG. 6 using a press process in accordance with an embodiment of the present invention;

FIG. 9 is a schematic perspective view of a printing roll and a rubber plate including a printing pattern;

FIGS. 10 and 11 are lateral sectional views of apparatuses for printing an alignment film according to other embodiments of the present invention; and

FIG. 12 schematically illustrates the printing of an alignment film by a printing roll of the apparatuses shown in FIGS. 10 and 11.

Embodiments of the present invention and their advantages are best understood by referring to the detailed description that follows. It should be appreciated that like reference numerals are used to identify like elements illustrated in one or more of the figures. It is also noted that the figures are not necessarily drawn to scale.

### DETAILED DESCRIPTION

Apparatuses and methods for providing an alignment film according to embodiments of the present invention will now be described more fully with reference to the accompanying drawings. The present invention may, however, be embodied in many different forms and should not be construed as limited to the embodiments set forth herein.

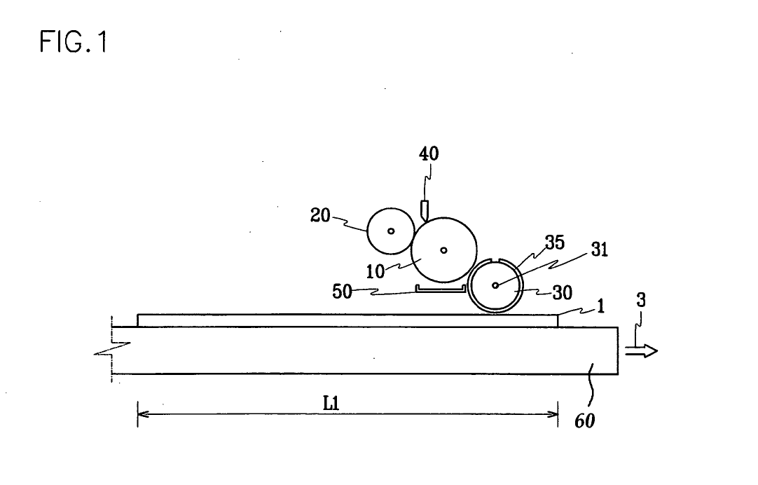

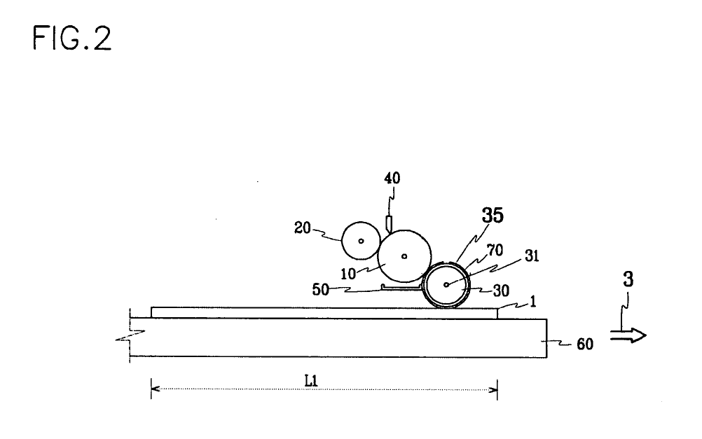

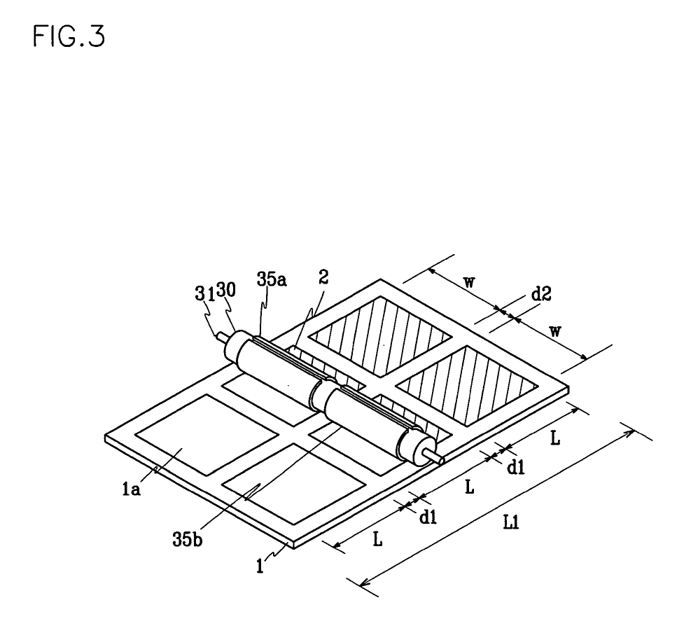

Referring now to FIGS. 1 through 5, apparatuses for printing an alignment film according to embodiments of the present invention are described in greater detail. FIGS. 1 and 2 are lateral sectional views of apparatuses for forming an alignment film according to embodiments of the present invention, FIG. 3 schematically illustrates the printing of an alignment film by a printing roll of the apparatuses shown in FIGS. 1 and 2, and FIGS. 4 and 5 are expanded sectional views of the printing roll of the apparatuses shown in FIGS. 1 and 2, respectively.

Referring now to FIGS. 1 and 2, each of the respective apparatuses for printing an alignment film according to embodiments of the present invention includes three rollers engaged with one another, a dispenser 40, a bucket 50, and a printing table 60.

The three rollers include an anilox roll 10, a doctor roll 20 engaged with the anilox roll 10, and a printing roll 30 engaged with the anilox roll 10.

Dispenser 40 is disposed adjacent to anilox roll 10 and dispenses alignment material on a circumferential or contact surface of anilox roll 10. The alignment material includes but is not limited to organic material, such as a polyimide-based material, and inorganic material.

Doctor roll 20 moves forward and backward along its axis with its circumferential surface contacting the circumferential surface of anilox roll 10 to uniformly distribute the alignment material on the circumferential surface of anilox roll 10. Doctor roll further doctors off excess alignment material from anilox roll 10 to provide better control over ink transfer.

Bucket 50 is disposed under anilox roll 10 and receives and gathers the alignment material dropped from anilox roll 10 during the distribution of the alignment material by doctor roll 20.

Anilox roll 10 meters the alignment material to a uniform thickness onto printing roll 30. The surface of anilox roll 10 may be engraved with tiny uniform cells that carry and deposit a uniform amount of alignment material onto printing roll 30. Anilox roll 10 may vary in the size and configuration of the cells to carry different amounts of alignment material depending on printing requirements.

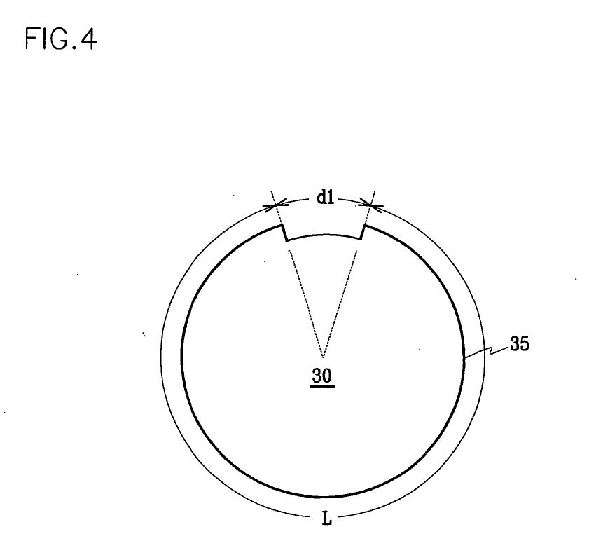

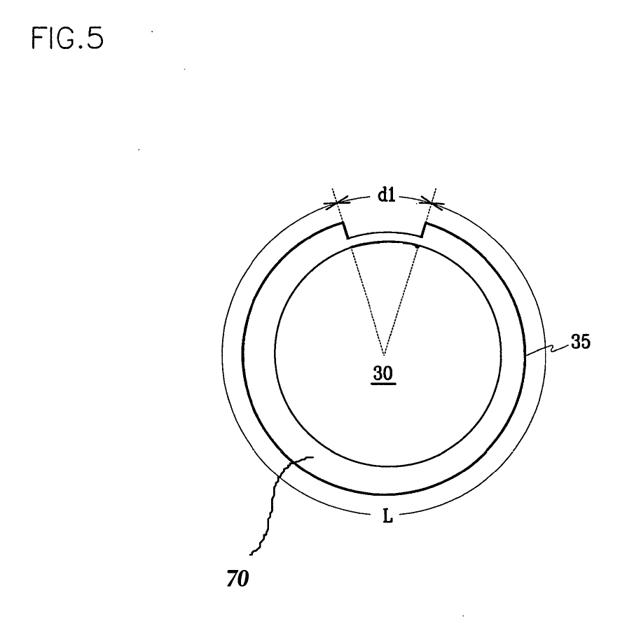

Printing roll 30 carries a predetermined prominent printing pattern 35 on its circumferential surface, and the printing pattern 35 is integrated into printing roll 30 as shown in FIGS. 1 and 4 or formed on a rubber plate 70 that is attached to the circumferential surface of printing roll 30 as shown in FIGS. 2 and 5. Rubber plate 70 may be attached to printing roll 30 by an adhesive, tape, or other known technique.

Printing roll 30 shown in FIGS. 1 and 4 and rubber plate 70 shown in FIGS. 2 and 5 may be made of synthetic rubber in one embodiment. An example of synthetic rubber used for printing roll 30 or rubber plate 70 is ethylene propylene diene monomer (EPDM) or terpolymer, that contains ethylene, propylene, and non-conjugated diene. EPDM can be vulcanized by several chemical or physical processes, including by treatment with sulfur, peroxide, phenol resin, and/or radiation. The vulcanization by sulfur can be enabled by diene. EPDM is highly durable and remarkably resistant to ozone, weather, heat, and solvent, for example. In addition, EPDM has a smaller specific gravity than other synthetic rubbers and enables high degree filling of tamping or oils due to a high wetting property. Accordingly, EPDM is a very cost effective synthetic rubber.

The alignment material coated on anilox roll 10 is transferred to the raised surfaces or prominences of the printing pattern 35 by contacting the printing pattern 35 of printing roll 30 with the surface of anilox roll 10.

Printing table 60 mounts a substrate 1 and moves in a direction 3 perpendicular to the axis of printing roll 30. During the movement of printing table 60, printing roll 30 rotates around its axle 31 to transfer the alignment material from the surface of the printing pattern 35 to substrate 1 such that the alignment material is coated on substrate 1. As a result, substrate 1 is covered with an alignment film having a pattern determined by the printing pattern 35 of printing roll 30. Printing table 60 thus applies proper pressure to printing roll 30, thereby enabling transfer of the printing pattern 35 onto substrate 1.

The alignment film printed on substrate 1 is cured at a predetermined temperature and rubbed with a rubbing roll (not shown). The rubbing orients or defines a pretilt of the liquid crystal molecules on the surface of the printed alignment film in one direction.

In accordance with the present invention, the circumference of printing roll 30, in one embodiment including rubber plate 70 and in another embodiment excluding rubber plate 70, is smaller than the length L1 of substrate 1 such that more than one rotation of printing roll 30 completes the printing of the alignment material on substrate 1. The circumference of printing roll 30 (including or excluding rubber plate 70) may be substantially equal to the length L1 of substrate 1 divided by an integer, i.e., the length L1 of substrate 1 may be equal to multiples of the circumference of printing roll 30. The printing roll thus has a circumference which is substantially equal to a length of the substrate divided by a whole number. In this case, the alignment film pattern printed on substrate 1 includes a pattern unit repeatedly arranged in the moving direction of printing table 60.

FIG. 3 shows that a rectangular pattern unit 2 of the printed alignment film pattern is arranged three times along the moving direction of printing table 60 and arranged twice along the axis direction of printing roll 30. The pattern unit 2 has a length L and a width W and adjacent pattern units 2 in the moving direction of printing table 60 are spaced apart by a distance d1, while adjacent pattern units 2 in the axis direction of printing roll 30 are spaced apart by a distance d2. Printing roll 30 rotates three times to form such an alignment film pattern. However, it should be understood that printing roll 30 may rotate a different number of times depending on the substrate length and alignment film pattern desired.

In order to form such an alignment film pattern, the predetermined printing pattern 35 formed on printing roll 30 includes two identical prominences 35a and 35b arranged in the axis direction of printing roll 30. Referring to FIGS. 3-5, each prominence 35a or 35b has a circumferential length equal to L and a width equal to W. The prominences 35a and 35b are spaced apart from each other along an axial direction by a distance equal to d2, and a circumferential distance between opposite edges of each prominence 35a or 35b, which are concentric to axle 31 of printing roll 30, is about equal to d1.

Substrate 1 used for the LCD includes a plurality of device partitions that will be separated along lines after forming the alignment film. Each device partition serves as a panel for an LCD and includes a display area 1a (FIG. 3) on which liquid crystal will be disposed. Each pattern unit 2 is disposed on a display area 1a of a device partition and a sealant (not shown) will be dispensed around the display area 1a. The display area 1a may be provided with a plurality of pixel electrodes (not shown), a plurality of TFTs (not shown), a plurality of color filters (not shown), and a plurality of signal lines (not shown).

As describe above, printing roll 30 and rubber plate 70 according to these embodiments are made of light synthetic rubber and have a small size such that the cost for manufacturing printing roll 30 and rubber plate 70 is reduced. In particular, the device shown in FIG. 1 requires no rubber plate such that it further reduces the manufacturing cost. Furthermore, the devices can be employed to a large substrate by rotating printing roll 30 multiple times.

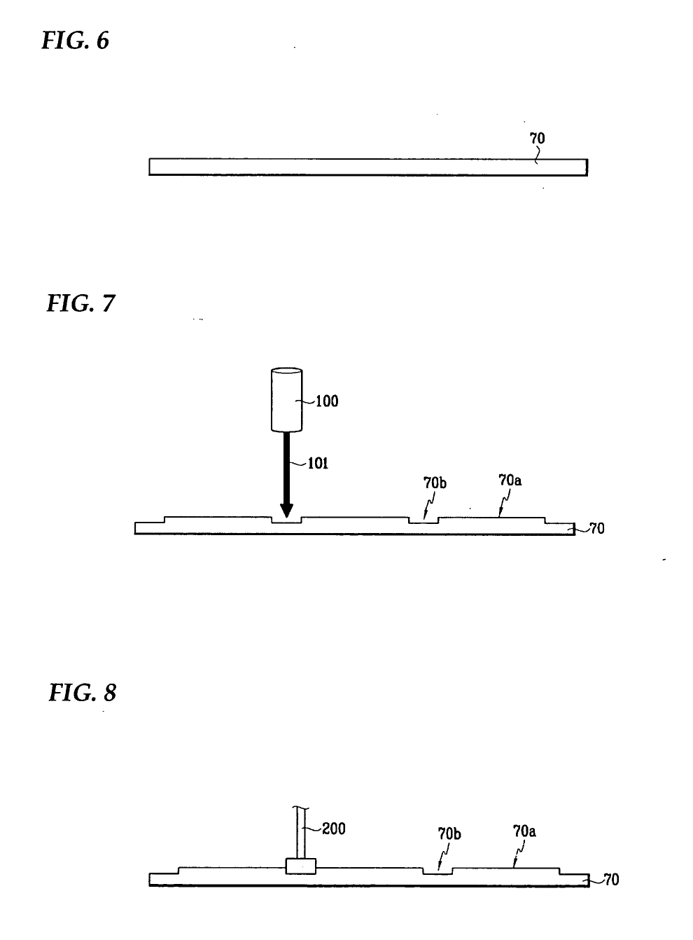

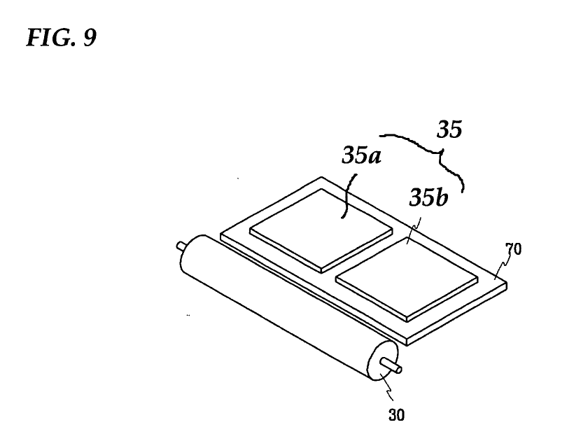

Now, a rubber plate including a printing pattern shown in FIGS. 2 and 5 will be described in detail with reference to FIGS. 6-9. FIG. 6 is a sectional view of a rubber plate for a printing roll according to an embodiment of the present invention, FIG. 7 illustrates the formation of a printing pattern on the rubber plate shown in FIG. 6 using a laser beam process, FIG. 8 illustrates the formation of a printing pattern on the rubber plate shown in FIG. 6 using a press process, and FIG. 9 is a schematic perspective view of a printing roll and a rubber plate including a printing pattern.

Referring to FIG. 6, a rubber plate 70, in one example made of EPDM, is prepared. Rubber plate 70 can be mechanically processed in various ways. In one example, rubber plate 70 is processed in a similar manner as a photosensitive resin plate (not shown) that can be processed by photolithography. Rubber plate 70 is mechanically processed by a laser beam process shown in FIG. 7, a press process shown in FIG. 8, or a sputtering process (not shown) to form depressions 70b and prominences 70a. Prominences 70a will receive the alignment material from anilox roll 10 for printing the alignment material pattern onto the substrate. FIG. 7 schematically shows that a laser beam 101 from a laser beam generating device 100 may be illuminated onto portions of rubber plate 70 to form depressions 70b. FIG. 8 schematically shows that a press 200 may apply pressure to portions of the rubber plate 70 to form depressions 70b.

Advantageously, the above-described mechanical processes do not require a separate pattern film that is typically needed for photolithography. Accordingly, the mechanical processing can be advantageously applied to a large rubber plate including several prominences and depressions with less cost and greater efficiency.

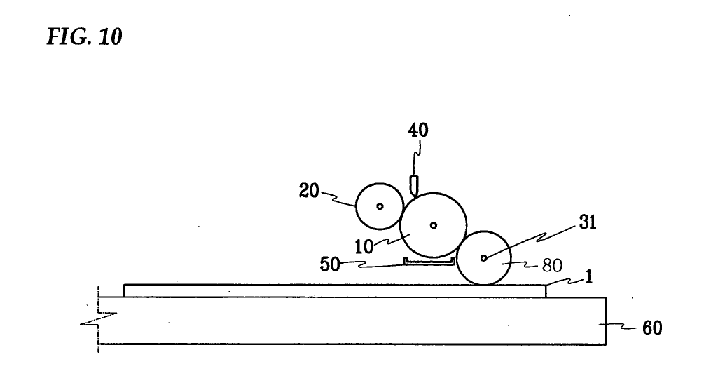

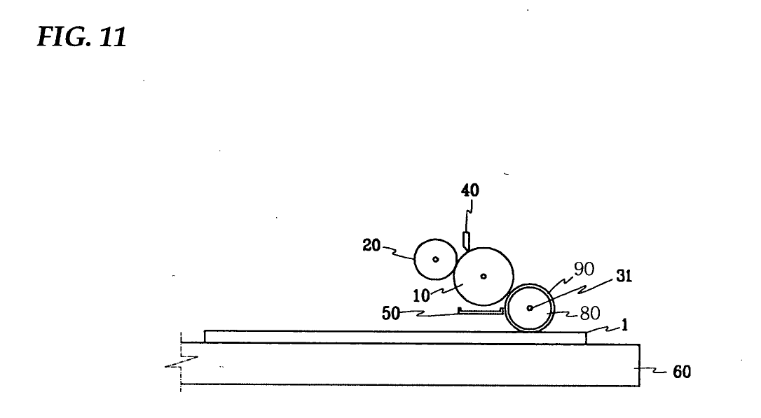

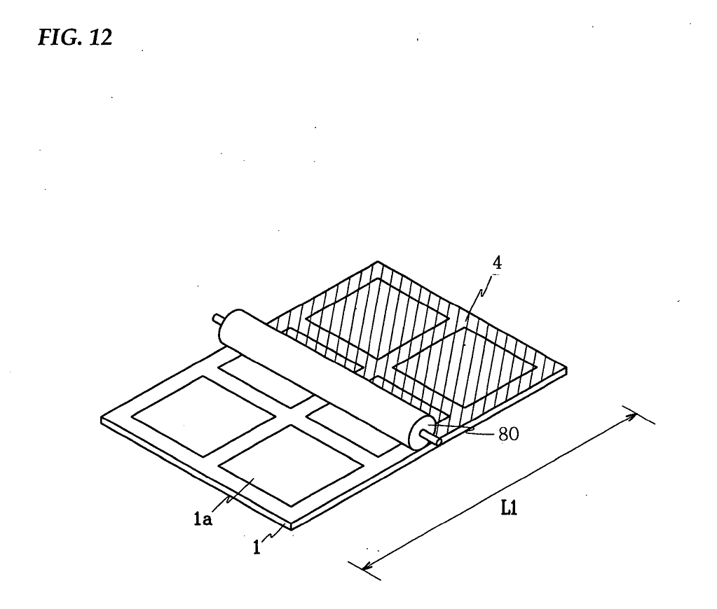

Now, apparatuses for printing an alignment film on a substrate according to other embodiments of the present invention are described in detail with reference to FIGS. 10 through 12. FIGS. 10 and 11 are lateral sectional views of apparatuses for printing an alignment film according to other embodiments of the present invention. FIG. 12 schematically illustrates the printing of an alignment film by a printing roll of the apparatuses shown in FIGS. 10 and 11.

Referring to FIGS. 10 and 11, apparatuses for printing an alignment film according to these embodiments have similar configurations as those shown in FIGS. 1 and 2, respectively. Thus, each of the apparatuses also includes an anilox roll 10, a doctor roll 20, a printing roll 80, a dispenser 40, a bucket 50, and a printing table 60 mounting a substrate 1. A rubber plate 90 may also be attached to the circumferential surface of printing roll 80 in one embodiment.

Different from FIGS. 1 and 2, printing roll 80 and rubber plate 90 do not have a predetermined pattern, as shown in FIGS. 10 and 11, respectively. Accordingly, the printing roll 80 coats an alignment film 4 having no pattern on substrate 1 as shown in FIG. 12.

A desired pattern of printed alignment film 4 is then obtained by photolithography in one embodiment. In further detail, a photoresist film is coated on alignment film 4 and an exposure mask (not shown) having the alignment film pattern is aligned with substrate 1. The photoresist film is exposed to light through the exposure mask and developed to form a photoresist pattern. Alignment film 4 is then dry etched using the photoresist pattern as an etch mask to form a desired pattern. When alignment film 4 is made of photosensitive material, there is no need to coat the photoresist film and the desired pattern of the alignment film 4 is obtained only by photolithography without the dry etching.

Alternatively, a desired pattern of alignment film 4 may be formed by illuminating a laser beam.

Advantageously, since printing roll 80 has no pattern, the diameter of printing roll 80 can be made as small as possible independent from the length of substrate 1. In addition, the alignment between printing roll 80 and substrate 1 may not be significant, and the cleaning of printing roll 80 is very simple.

While the present invention has been described in detail with reference to the above-described embodiments, those skilled in the art will appreciate that various modifications and substitutions can be made thereto without departing from the spirit and scope of the present invention as set forth in the appended claims that follow.

1. A system for printing an alignment film, comprising:
an anilox roll operably engaged with a dispenser for providing an alignment material on the anilox roll;
a printing roll operably engaged with the anilox roll to receive alignment material; and
a table operably engaged with the printing roll, the table mounting a substrate onto which is transferred alignment material from the printing roll.

2. The system of claim 1, wherein the alignment material is selected from the group consisting of organic material and inorganic material.

3. The system of claim 1, wherein the printing roll is comprised of a polymer including ethylene propylene diene monomer.

4. The system of claim 1, wherein the printing roll has a circumference which is less than a length of the substrate.

5. The system of claim 1, wherein the printing roll has a circumference such that more than one rotation of the printing roll is required to print the alignment material along a full length of the substrate.

6. The system of claim 1, wherein the printing roll has a circumference which is substantially equal to a length of the substrate divided by a whole number.

7. The system of claim 1, wherein the printing roll has a printing pattern on an outer surface.

8. The system of claim 1, wherein the printing roll includes a plate having a printing pattern.

9. The system of claim 8, wherein the plate is comprised of a polymer including ethylene propylene diene monomer.

10. The system of claim 1, wherein the substrate includes a liquid crystal display panel.

11. The system of claim 1, wherein the substrate includes a plurality of liquid crystal display panels.

12. The system of claim 1, wherein the substrate is mounted between the printing roll and a top surface of the table.

13. The system of claim 1, further comprising a doctor roll operably engaged with the anilox roll.

14. A system for printing an alignment film, comprising:
an anilox roll operably engaged with a dispenser for providing an alignment material on the anilox roll;
a printing roll operably engaged with the anilox roll to receive alignment material; and
a table operably engaged with the printing roll, the table mounting a substrate onto which is transferred alignment material from the printing roll via multiple rotations of the printing roll.

15. The system of claim 14, wherein the printing roll has a circumference which is substantially equal to a length of the substrate divided by a whole number.

16. The system of claim 14, wherein the printing roll has a printing pattern on an outer surface.

17. The system of claim 14, wherein the printing roll includes a plate having a printing pattern.

18. The system of claim 14, wherein the substrate includes a liquid crystal display panel.

19. The system of claim 14, wherein the substrate includes a plurality of liquid crystal display panels.

20. A method of printing an alignment film, comprising:
transferring alignment material from a dispenser to an anilox roll;
transferring alignment material from the anilox roll to a printing roll including a printing pattern; and
transferring alignment material from the printing roll to a substrate mounted on a table via multiple rotations of the printing roll.

21. The method of claim 20, wherein the alignment material is selected from the group consisting of organic material and inorganic material.

22. The method of claim 20, wherein the printing roll has a circumference which is less than a length of the substrate.

23. The method of claim 20, wherein the printing roll has a circumference which is substantially equal to a length of the substrate divided by a whole number.

24. The method of claim 20, wherein the printing roll has a printing pattern on an outer surface.

25. The method of claim 20, wherein the printing roll includes a plate having a printing pattern.

26. The method of claim 25, wherein the printing pattern is formed by processing the plate with a laser or a press.

27. The method of claim 20, wherein the substrate includes a liquid crystal display panel.

28. The method of claim 20, wherein the substrate includes a plurality of liquid crystal display panels.

29. The method of claim 20, further comprising engaging a doctor roll with the anilox roll to evenly distribute the alignment material on the anilox roll.

30. The method of claim 20, further comprising collecting alignment material in a collector under the anilox roll.

31. The method of claim 20, further comprising forming the printing pattern of alignment material on the substrate.

32. A method of printing an alignment film, comprising:
transferring alignment material from a dispenser to an anilox roll;
transferring alignment material from the anilox roll to a printing roll;
transferring alignment material from the printing roll to a substrate mounted on a table via multiple rotations of the printing roll to form an alignment film; and
patterning the alignment film.

33. The method of claim 32, wherein the alignment film is patterned by photolithography.

34. The method of claim 32, wherein the alignment film is patterned by laser illumination.
